(19) United States
(12) Patent Application Publication
(10) Pub. No.: US 2009/0295761 A1
(43) Pub. Date: Dec. 3, 2009

(54) LIGHT CONTROLLED SCREEN

(75) Inventor: Qing-Hua Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,, Shenzhen City (CN); HON HAI PRECISION INDUSTRY CO., LTD., Tu-Cheng (TW)

(21) Appl. No.: 12/208,089

(22) Filed: Sep. 10, 2008

(30) Foreign Application Priority Data
May 30, 2008 (CN) 200810301848.2

(51) Int. Cl. G06F 3/042

(52) U.S. Cl. 345/183

(57) ABSTRACT

A screen controlled by light includes a display and a resistor film cover on an outer surface of the display. The resistor film includes two separated transparent conducting layers. A plurality of photoresistors is coupled between the two transparent conducting layers, wherein the resistance value of each photoresistor is capable of varying under different light conditions.

### BACKGROUND

1. Technical Field

The present invention relates to light controlled screens.

2. Description of Related Art

Currently, there are many types of input devices for performing various operations within a computer system. The operations generally involve moving a cursor and/or making selections on a display screen. By way of example, the input devices may include buttons or keys, mice, trackballs, touch pads, joy sticks, and touch screens. Touch screens, in particular, are becoming increasingly popular due to their ease and versatility of operation as well as their declining price. Touch screens allow users to make selections and move a cursor by simply touching the display screen with a finger or stylus. In general, the touch screen recognizes the touch and position of the touch on the display screen, allowing the computer system to interpret the touch and perform an action based on the touch event. However, touch screens are easily prone to being scratched, thereby causing the touch screen to appear distorted.

Therefore, there is room for improvement within the art.

### BRIEF DESCRIPTION OF THE DRAWINGS

FIG. 1 is a sectional view of a screen.

FIG. 2 is a sketch view of the screen of FIG. 1.

FIG. 3 is another sketch view of the screen of FIG. 1.

FIG. 4 is a table of the control mode of the screen of FIG. 3.

### DETAILED DESCRIPTION OF THE EMBODIMENTS

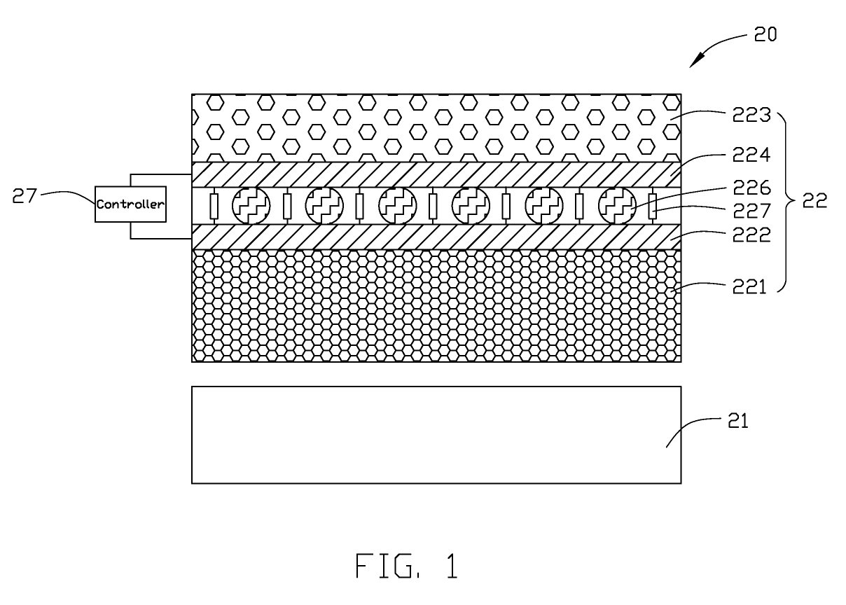

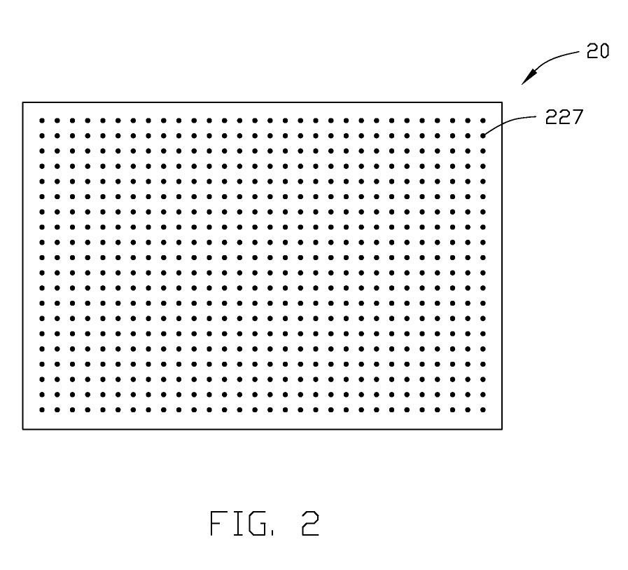

Referring to FIGS. 1 and 2, a screen 20 includes a display 21, a resistor film 22 covered on an outer surface of the display 21, and a controller 27. The resistor film 22 is a multilayer film, which includes a transparent base layer 221 adjacent to the display 21, a transparent conducting layer 222 painted on the transparent base layer 221, a transparent covering layer 223 covered on the transparent base layer 221, and another transparent conducting layer 224 painted on the transparent covering layer 223. The two transparent conducting layers 222 and 224 face each other. A plurality of fine transparent insulating spots 226 are sandwiched between the two conducting layers 222 and 224 to separate the two conducting layers 222, 224 from each other. The controller 27 is connected to the two conducting layers 222, 224. A plurality of photoresistors 227 are coupled between the two conducting layers 222, 224.

The resistance value of each photoresistor 227 is capable of varying when a light source shines on the photoresistor 227 in response to changing lighting conditions. The light source may be laser, infrared, and ultraviolet light, among others. In one embodiment, the photoresistor 227 has a large resistance value under normal lighting conditions and insulate the two conducting layers 222, 224. When a focused light source is directly shone on photoresistor 227, the resistance value of photoresistor 227 decreases. In addition, different modes of light shining can correspond to different variation modes of the resistance value of the photoresistors 227. The controller 27 can detect changes in the resistance value of the photoresistors 227, and can respond to these changes by triggering different operations associated with the variation in resistance change to occur.

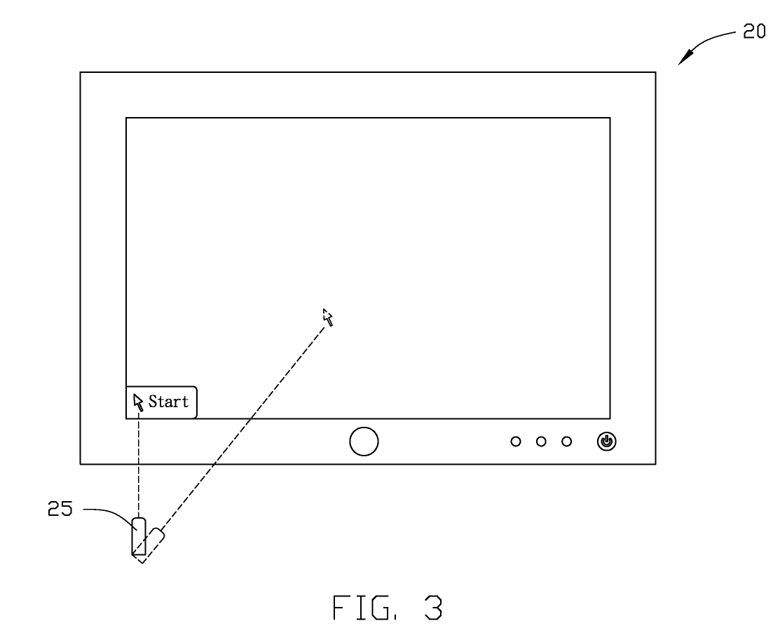

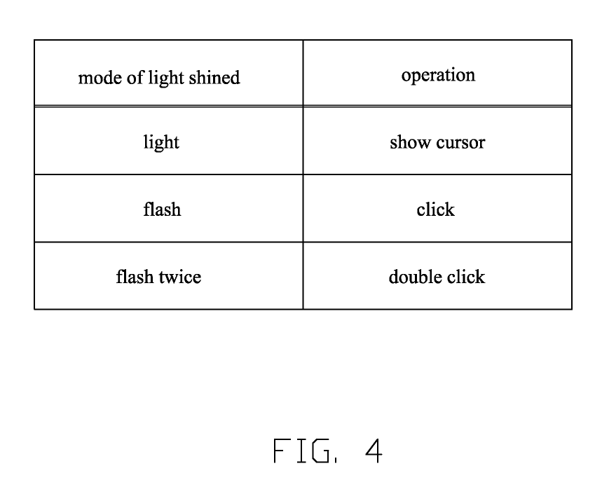

Referring to FIGS. 3 and 4, an exemplary embodiment of the screen 20 can be controlled by a light emitter 25 which can emit light to induce varying resistance values of the photoresistors 227. Upon detecting different modes of lightshining, different operations can be triggered. FIG. 4 shows an exemplary relationship between the mode of light shone on the screen 20 and the associated triggered operation. When the light is shone on an area of the screen 20, the controller 27 detects variations of the resistance value of the photoresistors 227 at the shone area, and the controller 27 causes the screen 20 to show a cursor at the shone area (see FIG. 3). When the shone light is flashed once at an area of screen 20, the controller 27 detects corresponding variation of the resistance value of the photoresistors, and causes the cursor to click (e.g. single left-mouse button operation). When the shone light is flashed twice at an area of screen 20, the controller 27 detects corresponding variation of the resistance value of the photoresistors, and causes the cursor to double-clicks (e.g. double-click left-mouse button operation). Other operations also can be triggered corresponding to other modes of light shone on an area of screen 20. Therefore, by using the screen 20, information or instructions can easily be input without having to physically touch the screen 20.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A screen controlled by light, the screen comprising:
a display;
a resistor film covered on an outer surface of the display, the resistor film comprising two separated transparent conducting layers, a plurality of photoresistors coupled between the two transparent conducting layers, the resistance value of each photoresistor capable of varying under different light conditions.

2. The screen of claim 1, wherein a plurality of fine transparent insulating spots are sandwiched between the two transparent conducting layers to separate the two transparent conducting layers from each other.

3. The screen of claim 1, wherein the resistor film comprises a transparent base layer adjacent to the display and a transparent covering layer covered on the transparent base layer, the two transparent conducting layers are painted on adjacent sides of the transparent base layer and the transparent covering layer.

4. The screen of claim 3, wherein each photoresistor has a large resistance value under normal lighting conditions to insulate the two conducting layers, and has a smaller resistance value when light is shone on the photoresistor.

5. The screen of claim 4, wherein the light is one of: laser, infrared, and ultraviolet light.

6. The screen of claim 1, wherein a controller is coupled to the two transparent conducting layers to detect variance of resistance value of the plurality of photoresistors and responds by triggering associated operations.

7. A combination, comprising:
a screen comprising:
a display;
a resistor film covered on the display, the resistor film comprising a plurality of photoresistors;
a controller electronically connected to the photoresistors, the controller triggering different operations in response to different changes of the resistance value of the photoresistors;
a light emitter emitting light on the screen to induce changes to the resistance values of the photoresistors in different modes to trigger different operations.

8. The combination of claim 7, wherein the resistor film comprises two separated transparent conducting layers, and the plurality of photoresistors is coupled between the two transparent conducting layers.

9. The combination of claim 8, wherein the controller is coupled to the two transparent conducting layers to detect changes in the resistance values of the photoresistors and respond by triggering associated operations.

10. The combination of claim 9, wherein the photoresistor has large resistance value under normal lighting conditions to insulate the two conducting layers, and has a smaller resistance value when light is shone on the photoresistor.

11. The combination of claim 10, wherein the light is one of: a laser, infrared, or ultraviolet light.

12. The combination of claim 8, wherein a plurality of fine transparent insulating sports is sandwiched between the two transparent conducting layers to separate the two transparent conducting layers from each other.

13. The combination of claim 8, wherein the resistor film comprises a transparent base layer adjacent to the display and a transparent covering layer covered on the transparent base layer, the two transparent conducting layers are painted on adjacent sides of the transparent base layer and the transparent covering layer.
